(19) United States
(12) Patent Application Publication
(10) Pub. No.: US 2025/0158425 A1
(43) Pub. Date: May 15, 2025

(54) SERIES BATTERY PACK SELF-BALANCING DEVICE CAPABLE OF INDEPENDENTLY WORKING IN SINGLE STRING, AND SELF-BALANCING BATTERY CELL

(71) Applicant: HEFEIPINWANG NEW ENERGY CO., LTD., Hefei, Anhui (CN)

(72) Inventors: Tiancai WANG, Hefei (CN); Xinming WANG, Hefei (CN); Shuying LI, Hefei (CN); Famg WANG, Hefei (CN); Zheng ZHANG, Hefei (CN); Zhenting WANG, Hefei (CN)

(73) Assignee: HEFEIPINWANG NEW ENERGY CO., LTD., Hefei, Anhui (CN)

(21) Appl. No.: 18/833,298

(22) PCT Filed: Jan. 16, 2023
(86) PCT No.: PCT/CN2023/072350

§ 371 Date: Jul. 25, 2024

(30) Foreign Application Priority Data
Jan. 26, 2022 (CN) 202210094433.2

(51) Int. Cl. H02J 7/00

(52) U.S. Cl. CPC H02J 7/0016; H02J 7/00309; H02J 7/0047; H02J 7/007182; H02J 7/007194

(57) ABSTRACT

A series battery pack self-balancing device is capable of independently working in a single string and a self-balancing battery cell. Each battery string in the battery pack is provided with an independent self-balancing device, the self-balancing device is powered by the battery string, and the self-balancing device comprises a voltage detection unit, a timing unit and a discharging unit. When it is detected that the voltage of the battery string exceeds a balancing starting threshold value, discharging of the battery string is started for a specified duration, and the balancing is stopped after discharging is finished; each self-balancing device can independently complete starting, running and ending of the balancing and is used for maintaining or improving the balanced state of the series battery pack. Self-balancing battery cells using the self-balancing device are assembled into a battery pack, so that the battery pack has a self-balancing function.

### CROSS REFERENCE TO RELATED APPLICATIONS

This application claims the benefit of priority to Chinese Patent Application No. 202210094433.2, filed on Jan. 26, 2022, the contents of which are incorporated herein by reference.

### FIELD OF THE INVENTION

The present disclosure relates to the technical field of series battery pack balancing, and in particular, to a series battery pack self-balancing device capable of independently working in a single string and a self-balancing battery cell using the same.

### BACKGROUND OF THE INVENTION

A battery cell refers to one battery, which is commonly known as a single battery cell or a single battery; a battery string is composed of a plurality of battery cells connected in parallel, the voltage remains unchanged, more power can be accommodated, and a greater current can flow out. A series battery pack is composed of a plurality of battery strings connected in series, which has a higher voltage and greater total power than a single battery string. However, due to differences in production processes, temperature differences, micro-leakage, internal damage and other reasons, there are certain differences in the real-time capacity of each battery string, which accumulate over time. When there is a situation where individual battery strings cannot be fully charged but are the first to discharge and run out of power earlier, it is necessary to maximize the capacity of the battery pack through the balancing technology.

Battery balancing falls into two broad categories of active balancing and passive balancing. Active balancing is achieved by the method of energy transfer, has the advantage of high efficiency, but is not widely used due to the complex structure, high risk; passive balancing mainly improves the consistency of the battery voltage by dissipating the energy of a high-voltage battery string, which is widely used due to its simple structure and high reliability. However, existing passive balancing methods still suffer from the following disadvantages, particularly for lithium iron phosphate batteries, which do not work well enough.

The prior art realizes balancing under the overall control of the master controller (MCU), the working principle is that after the battery front-end sampling chip AFE located in the high voltage region collects information such as voltages of all battery strings, through the isolation communication line, the information is uniformly sent to the MCU located in the low voltage region, and the MCU runs the balancing algorithm based on the information such as the voltages, and then controls the on-off of the balancing management unit of the battery front-end sampling chip AFE located in the high voltage region through the isolation communication line. This approach to balancing suffers from the following shortcomings:

1. As shown in FIG. 1, in order to maintain balancing, the communication between the entire master controller MCU and its supporting power supply DC, isolation communication and other components, and between chips and between modules, such as I2C, UART, CAN, 485, etc., all need to be in operation, and additional electric energy is also consumed in addition to the balancing itself. For electric buses, continuous balancing requires an additional consumption of around 20 W. The consumption of additional electric energy is especially prominent in the balancing mode of slow discharge for a long period of time. Therefore, for the current electric vehicles on the market, the balancing time is usually controlled within 30 minutes for each time.

2. The master controller (MCU) needs communication to coordinate and manage all battery strings, and requires many communication lines. For the application of more than 150 strings on buses, especially in the scene where old vehicles are equipped with high-power balancing equipment, the installation of newly loaded communication harnesses is a big problem because the previous harness installation supporting mold is already finalized.

Therefore, the conventional battery cell does not have control equipment inside, and additional balancing equipment is required after a battery pack is formed by the battery cells, which requires a battery pack manufacturer to purchase the balancing equipment, resulting in an increased difficulty in developing a battery pack.

### SUMMARY OF THE INVENTION

In response to the shortcomings associated with existing balancing solutions, the present disclosure provides a self-balancing device capable of independently working in a single string to perform balancing of the entire battery pack. There is no need for overall control from the balancing host, no need for the cooperation of the supporting isolated power supply and isolated communication device, only the self-balancing device needs to work, especially under long-term balancing conditions, the energy-saving advantage is obvious. The communication line between the balancing module and the host and its wiring effort can be saved, the construction difficulty can be reduced, and the cost can be saved. Especially for applications where there are many strings and communication cables cannot be installed, such as the electric buses or other electric vehicles that need to be equipped with balancing equipment after one year of operation, where the mold is finalized and cannot accommodate additional communication harnesses, the advantages of assembly convenience are more obvious. The battery cells equipped with the self-balancing devices can realize the automatic balancing of the battery pack after forming the battery pack, which reduces the difficulty of developing the battery pack.

In a first aspect, the present disclosure protects a series battery pack self-balancing device capable of independently working in a single string. Each battery string in the series battery pack is provided with at least one self-balancing device for improving or maintaining the balanced state of the battery pack. The self-balancing device is connected to positive and negative poles of the battery string through a conductor, the battery string provides a working voltage for the self-balancing device.

The self-balancing device includes a voltage detection unit, a timing unit and a discharging unit, wherein the voltage detection unit is used for detecting a voltage of the battery string, and comparing the voltage with a threshold voltage to output a comparison result, the timing unit is used for timing and outputting a timing result, and the discharging unit is used for discharging the battery string.

The working process of the self-balancing device includes the following steps:
S1: after detecting that the voltage across the battery string is greater than the balancing starting threshold voltage VTHB by the voltage detection unit, starting discharging of the battery string by the discharging unit, and starting timing by the timing unit; and
S2: stopping discharging by the discharging unit when the timing duration reaches a predetermined time Δt1.

Further, the balancing starting threshold voltage VTHB is smaller than the battery string full charging threshold voltage VTHF, and Δt1 is greater than 80 seconds.

Further, the voltage detection unit is implemented by a voltage comparator or ADC.

Further, starting discharging of the battery string by the discharging unit, and starting timing by the timing unit in step S1 must also satisfy: the battery string voltage remains continuously higher than the balancing starting threshold voltage VTHB with a duration of Δt2 greater than 220 msec.

Further, the operation of the self-balancing device further includes the following process: the timing unit does not restart timing after the voltage across the battery string is greater than the balancing starting threshold voltage VTHB again during timing of the timing unit.

Further, the operation of the self-balancing device further includes the following process: after a balancing prohibiting condition occurs, the discharging unit is configured to prohibit discharging or terminate discharging;
the balancing prohibiting condition includes at least one of the following conditions: the battery string voltage Vi is smaller than the lowest balancing voltage threshold value VTHU; the battery string voltage Vi is greater than a voltage abnormally high threshold value VTHO; a self-balancing device temperature is greater than a high-temperature protection threshold value TTHO; and the ambient temperature is smaller than a low-temperature protection threshold value TTHU.

Further, the self-balancing device further includes a thermal fuse connected in series in a power supply channel of the self-balancing device, and after the temperature of the self-balancing device is higher than the fuse limit temperature, the thermal fuse is disconnected and the self-balancing device is powered off.

Further, the timing unit includes a clock source and a counter, the clock source being a RC oscillator or a crystal oscillator, and the counter composed of n flip-flops cascaded, n being greater than 21.

Further, the timing function of the timing unit is implemented using one or more of a 555-series timer, a MCU, an Application Specific Integrated Circuit, a FPGA, a PAL, a PLD, a GAL.

Further, the discharging unit includes a discharging circuit that is any one of: a constant current source discharging circuit; a resistive discharging circuit; and a discharging circuit composed of at least one of a diode, a voltage regulator tube, and a regulated power supply connected in series with a resistor.

Further, after the self-balancing device receives an external input stop signal, the self-balancing device stops or terminates balanced discharging.

In a second aspect, the present disclosure also protects a self-balancing battery cell including a battery cell and the self-balancing device as described above.

The present disclosure, by using the self-balancing device capable of independently working in a single string and the strategy, realizes the effect of single-string independent work and full battery pack balancing. Since additional equipment and isolated communication coordination are not required during balanced discharging, less power is consumed, it is more energy-saving and environmentally friendly, and communication wires are also saved, which greatly reduces the difficulty of installation and construction and reduces costs. The battery pack is composed of self-balancing battery cells including self-balancing devices, and the battery pack has a self-balancing function, which reduces the difficulty of developing the battery pack.

### BRIEF DESCRIPTION OF DRAWINGS

FIG. 1 is a schematic diagram of the working states of various supporting components during continuous balancing under the overall control of a master controller;

FIG. 2 is a schematic diagram of the working states of various supporting components during continuous balancing according to the present disclosure;

FIG. 3 is a schematic diagram of clock frequency division;

FIG. 4A is a diagram of an internal structure of a self-balancing device in a basic form according to the present disclosure;

FIG. 4B is a diagram of an internal structure of a self-balancing device in a form according to the present disclosure;

FIG. 5 is a control flow diagram of a MCU timing unit;

FIG. 6 is a block diagram of a self-balancing device and a schematic diagram of a self-balancing battery cell; and

FIG. 7 is a schematic diagram of different types of discharging circuits.

### DETAILED DESCRIPTION OF THE EMBODIMENTS

The present disclosure is described in further detail below with reference to the accompanying drawings and the detailed embodiments. Embodiments of the present disclosure have been presented for purposes of illustration and description, but are not intended to be exhaustive or limit the present disclosure to the disclosed form. Many modifications and variations will be apparent to those skilled in the art. Embodiments are selected and described to better illustrate the principles and practical applications of the present disclosure, and to enable those of ordinary skill in the art to understand the present disclosure so as to design various embodiments with various modifications suitable for a particular purpose.

Embodiments of the present disclosure provide a series battery pack self-balancing device capable of independently working in a single string, each battery string in the series battery pack being provided with at least one self-balancing device for improving or maintaining the balanced state of the battery pack, wherein the self-balancing device is connected to positive and negative poles of the battery string through a conductor, the battery string provides a working voltage for the self-balancing device.

The self-balancing device includes a voltage detection unit, a timing unit and a discharging unit, wherein the voltage detection unit is used for detecting a voltage of the battery string, and comparing the voltage with a threshold voltage to output a comparison result, the timing unit is used for timing and outputting a timing result, and the discharging unit is used for discharging the battery string.

The working process of the self-balancing device includes the following steps:
S1: after the voltage detection unit detects that the voltage across the battery string is greater than the balancing starting threshold voltage VTHB, the discharging unit starts discharging of the battery string, and the timing unit starts timing; and
S2: the discharging unit stops discharging when the timing duration reaches a predetermined time Δt1.

Embodiments of the present disclosure provide a self-balancing module capable of independently working in a single string: each battery string is equipped with a self-balancing device, and when the voltage of the battery string rises beyond the balancing starting threshold value, the function of balanced discharging to the battery string is started, and at the same time, timing is started, and the balanced discharging is turned off after the timing ends, or the balanced discharging is turned off when a balancing prohibiting condition occurs; of course, after the balanced discharging ends, when the balancing starting condition is met again, the balanced discharging can be started again. If the balancing starting and prohibiting conditions are met at the same time, balanced discharging is not started.

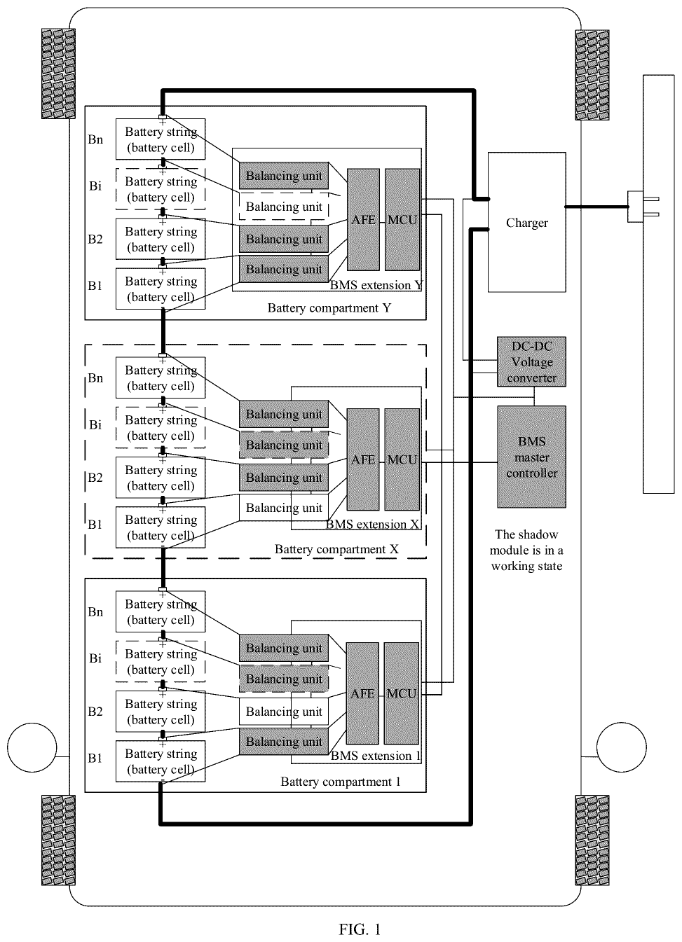

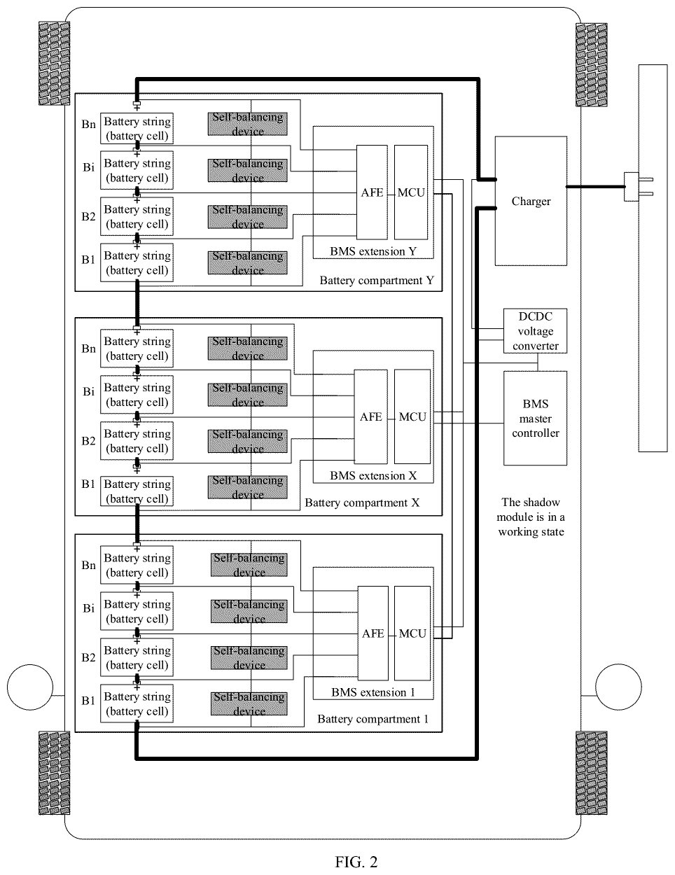

The self-balancing module can automatically complete the starting and ending of balancing independently, without the overall control of the master controller, and without communication with the master controller. After the battery pack is about to be fully charged or fully charged, the self-balancing module automatically decides whether to turn on the discharging function according to the voltage of the battery string. After charging is finished, the self-balancing module can still ensure the continuity of balancing by regular ending. The working states of the battery pack balancing supporting components are balanced under the overall control of the master controller (MCU) in the prior art. As shown in FIG. 1, during continuous balancing, the master controller, the DC-DC voltage converter, the MCU, and the AFE are all in the working state, and the communication between modules also needs to be continued. The state of the present disclosure is shown in FIG. 2. Compared with the prior art of FIG. 1, the self-balancing device capable of independently working in a single string provided by the disclosure only needs to charge the battery pack like conventional charging, and the self-balancing device can automatically open balancing for the battery string that meets the conditions. During continuous balancing, there is no need for the charger to be in the charging state all the time, and there is no need for the battery pack master controller MCU, the DC-DC voltage converter, the extension MCU, and the BMS AFE to be in the working state, and there is no need for continuous communication between different strings. In the process of installing the balancing device on the existing vehicle, using the self-balancing device of the disclosure only needs to connect each self-balancing module to both ends of each battery string, without laying additional communication lines. Step S1: after the voltage detection unit detects that the voltage across the battery string is greater than the balancing starting threshold voltage VTHB, the discharging unit starts discharging of the battery string, and the timing unit starts timing. The conditions for starting the balanced discharging of the battery string must be met: the battery string voltage Vi is greater than the balancing starting threshold value VTHB; or after Vi has been greater than VTHB, the battery string discharging and timing are started after a delay or other processing, and if Vi is not greater than VTHB, it does not constitute the starting condition of balanced discharging and timing. Once the balanced discharging and timing start, if the starting conditions of discharging and timing disappear, the continuous operation of the balanced discharging and timing is not affected. The discharging and timing starting conditions include situations where the battery string voltage Vi rises from low and is greater than the balancing starting threshold value VTHB, where Vi continues to be greater than VTHB, where Vi decreases from greater than VTHB to smaller than VTHB, or where Vi is higher than VTHB in other forms.

The balanced discharging ending conditions include: the specified timing duration Δt1 is ended. Of course, after balancing is closed, it can be reopened if it meets the balanced discharging starting conditions again. To further enhance the safety of the battery pack, the balanced discharging ending may also include some of the following conditions: the battery string voltage Vi is smaller than the lowest balancing voltage threshold value VTHU; the string voltage Vi is greater than the voltage abnormally high threshold value VTHO; the self-balancing device temperature is greater than the high-temperature protection threshold value TTHO; or the ambient temperature is smaller than a low temperature threshold value TTHU.

Different types of batteries have different parameters. For lithium iron phosphate batteries: VTHB is typically 3.4-3.64V, and a recommended value is 3.55V, VTHO is typically 3.7-3.8V, a recommended value is 3.8V, VTHU is typically 2.0-3.3V, a recommended value is 2.2V, VTHF is typically 3.65-3.7V, a recommended value is 3.65V. For ternary batteries: VTHB is typically 4.0-4.18V, a recommended value is 4.1V, VTHO is typically 4.3-4.5V, a recommended value is 4.4V, VTHU is typically 2.2-3.6V, a recommended value is 2.8V, VTHF is typically 4.2-4.4V, a recommended value is 4.4V. For lithium titanate batteries: VTHB is typically 2.65-2.8V, a recommended value is 2.7V, VTHU is typically 1.5-2.3V, a recommended value is 1.8V; TTHO is typically 50-150 degrees Celsius, a recommended value is 70 degrees Celsius; TTHU is typically −20-0 degrees Celsius, a recommended value is 0 degrees Celsius; it is also applicable to lead-acid batteries, nickel-hydrogen batteries and the like, which are not listed here.

The detailed structure of the self-balancing device is described below.

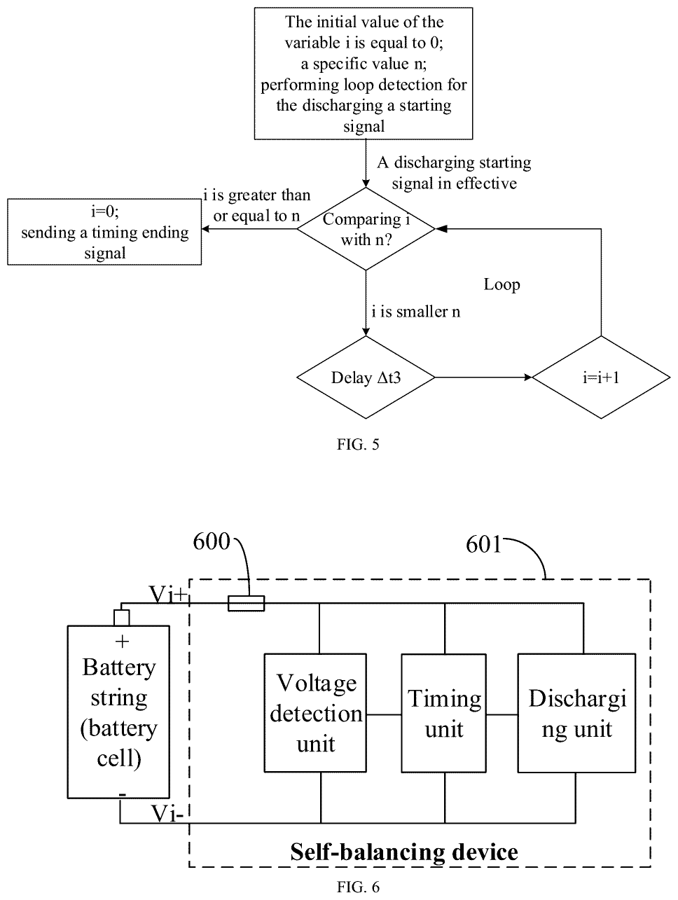

As shown in FIG. 2, each battery string in a series battery pack is provided with a self-balancing device capable of independently working in a single string. As the self-balancing device 601 of FIG. 6, the self-balancing device is connected to the positive and negative poles of the battery string through a conductor, the battery string provides the working voltage for the self-balancing device, no additional power supply or isolated power supply is required, thus facilitating low power consumption design and reducing cost; the self-balancing device detects and discharges the battery string; the self-balancing device mainly includes a voltage detection unit, a timing unit and a discharging unit; the self-balancing device can perform voltage judgment alone without communicating with the battery pack master controller and balanced discharging starting and ending, thus saving communication wires, construction and power costs.

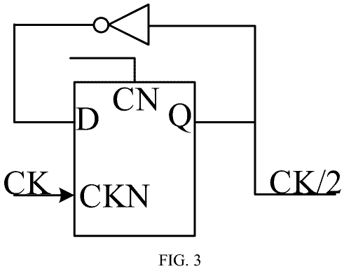

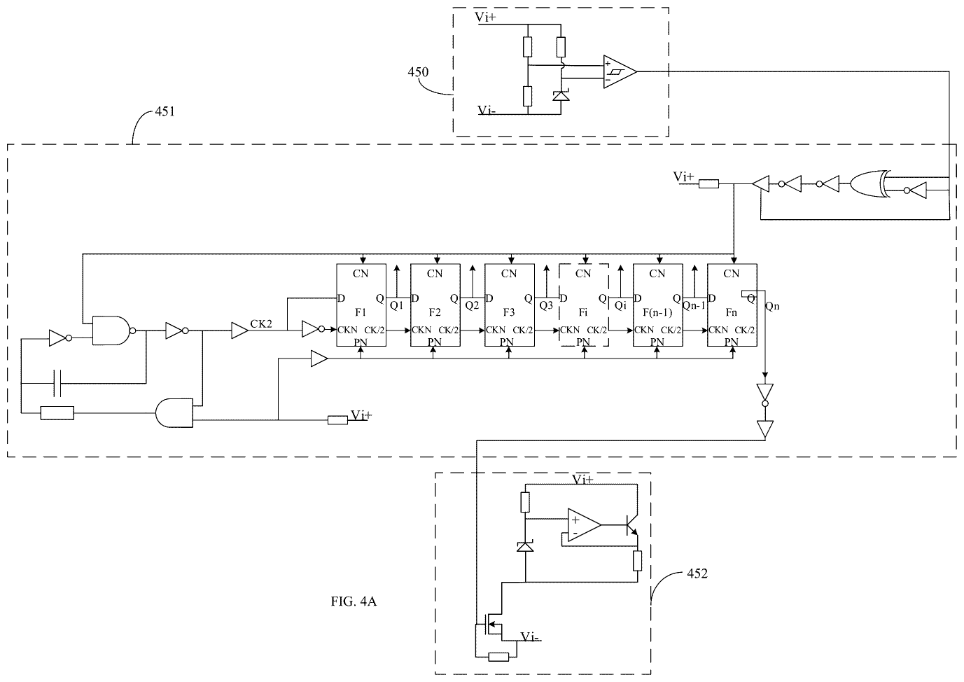

Global explanation: an ERSTN set signal 415 is connected to a plurality of places in FIG. 4B, and all signals named ERSTN are electrically connected together; Vi+, Vi− are the positive and negative power supplies of the battery strings, respectively; when an external input signal 423 is high, a reset circuit 414 may cause the voltage of the signal 415 to go low and then high after the self-balancing device is powered on, and modules 402, 403, 405, 406 are set. After the counting module 403, the counting module 405 and the flip-flop in FIG. 3 receive the low level or the low-level pulse at the input terminal CN, the flip-flop output Q is set to be a low level, and when a CKN receives a clock falling edge, a D port input signal is locked and the output signal Q=D is realized. The flip-flop output Q is set to be a high level after the counting module 405 receives the low level or low-level pulse at PN. Controllable tri-state gates 412 and 413 have output levels equal to input levels when an enable signal is at a high level, and their outputs are in a high-impedance state when the enable signal is at a low level. Unless otherwise specified, both external input signal 423 and signal 415 are defaulted to be at a high level in the following descriptions.

A most basic structure is shown in FIG. 4A, 450 is a voltage detection unit, the input terminals of which are connected to the positive and negative poles of the battery strings, respectively, the output terminal of the voltage detection unit is connected to an input terminal of the timing unit 451, when the battery voltage exceeds the balancing threshold value, the signal output by the voltage detection unit changes from a low level to a high level and is sent to a low pulse generating circuit of the timing unit, after the low pulse signal sets an RC oscillation module and the counting module, timing is started, and the discharging starting signal low level is output to the discharging unit 452, a discharging unit switch tube is closed and discharging is started; the timer continues to time, and when timing is finished, the output of the timing unit is high, the switch tube of the discharging unit 452 is disconnected, and discharging is stopped.

The working principle of the various subdivided modules will now be described on the basis of FIG. 4B. The basic structure of FIG. 4A corresponds to FIG. 4B. The output 428 of the voltage detection unit 401 is directly connected to the input of the module 404. A signal 420 directly controls the enable terminal of the tri-state gate 413. An AND gate 416, the module 402, the module 403 and the modules 407-410 are all removed. The tri-state gate 412 is removed and its input and output are connected together, the ETSTN is set to be at a high level. The above basic structure needs to be further extended for safety reasons, and will be described one by one below.

The voltage detection unit is used for acquiring a battery string voltage and comparing with a balancing starting threshold value VTHB, and outputting a comparison result. As in FIG. 4B, the voltage detection unit 401 includes, but not limited to, collecting the battery string voltage by resistor voltage division, and inputting the voltage to a non-inverting input terminal of a voltage comparator, wherein the inverting input terminal of the voltage comparator is input with a reference voltage source with a preset voltage, and the ratio of the input voltages of the non-inverting and inverting input terminals of the voltage comparator is equal to the ratio of the battery string voltage Vi to the balancing starting threshold value VTHB. According to the characteristics of the voltage comparator, when the non-inverting input terminal voltage is greater than the inverting input terminal voltage, the output of the voltage comparator is a high level, and vice versa, the output is a low level. For example, in the voltage detection unit 401, the voltage of the voltage regulator connected to the inverting input terminal of the comparator is 1.2V, the resistance value of a resistor connected to the non-inverting input terminal of the comparator and connected to Vi+ is 200K ohms, while the resistance value of a resistor connected to the non-inverting input terminal and connected to Vi− is 100K ohms, and the value of VTHB can be calculated as 1.2V*(200+100)/100=3.6V.

The voltage detection unit may also employ an ADC as a voltage detection method, the ADC includes but is not limited to an independent ADC, or an ADC built into an application specific integrated circuit, or an ADC built into an MCU, or an ADC built into a general-purpose chip such as a PLD, a FPGA, a GAL, or the like. Implementation methods include, but are not limited to, the following ways: a reference voltage source is used as a reference voltage for the ADC, the ADC collects the battery string voltage and outputs a corresponding digital signal, the outputted digital signal is compared with a preset digital threshold value, if the outputted digital signal is greater than the digital threshold value, a high level is outputted, if the outputted digital signal is smaller than the digital threshold value, a low level is outputted. The battery string voltage can also be taken as the reference voltage for the ADC, the reference voltage source is collected by the ADC, a high level is output when the collected reference voltage source is smaller than a specified numerical threshold value, a low level is output when the collected reference voltage source is greater than the specified numerical threshold value. For example: the reference voltage source is 1.2V, the target balancing starting threshold voltage is 3.6V, the ADC collects the battery string voltage to obtain a full magnitude of 4095, then the numerical threshold=4095*1.2/3.6=1365. It is also possible to separately collect the actual voltages of the reference voltage source and the battery string or the voltage of the battery string after resistive voltage division with the ADC, then compare them with the corresponding predetermined digital threshold values, and output the result.

The timing unit is used for timing and outputting a timing result. Referring to FIG. 4B, the set signal 415 is at a high level after power-on, when the counting module 405 and the clock module 406 receive the low-level pulse from the controllable tri-state gate 413, the output Qn of the flip-flop Fn is a low level and is used as the balanced discharging starting signal; timing is ended, the output Qn is the high level and is used as a balanced discharging ending signal.

The timing process and the circuit working principle will be gradually analyzed as follows:
the timing unit can be realized by combining a clock module with a counter, an adder, a subtractor or a frequency divider or other counting circuits. For the function of automatic stopping at the end of counting, the clock module is closed by the final output level of the counting module. For example, the AND gate 424 in FIG. 4B is inserted into the clock loop to stop the oscillation of the clock module. When the counting is reset, the clock module will start again. The timing unit of this embodiment combines the counting module 405 and the clock module 406 as shown in FIG. 4B into a timing unit. The clock module 406 generates a periodic continuous oscillating clock signal through the RC and the supporting circuit in the figure. The RC in the clock module 406 may be replaced by a crystal, and the clock module 406 may be replaced by a crystal oscillator, resonator, or other oscillators. The counting module 405 includes a series of flip-flop chains, wherein the falling edge of the clock input CKN of the flip-flop triggers locking D input signal and realizes Q=D. A CKN channel of the flip-flop F1 is connected in series with an inverter which has the delay and inversion functions. When designing the timing, the engineer who implements this circuit should ensure that the delay time of the inverter can make the CK2 level change from low to high. When the CKN falling edge after passing through the inverter reaches F1, the high-level signal at the D input terminal has been stabilized;
after the timing of the timing unit is started, when the CK2 goes from low to high, the CK2 generates a falling edge after passing through the inverter and enters the flip-flop F1, The F1 locks the high-level signal that has been stabilized at the input terminal D thereof, the subsequent flip-flop locks the own D input terminal signal when the own CKN receives a falling edge based on the same principle. Starting from the first stage, the high-level signal is gradually transmitted backward, stage by stage. The CK/2 output by each flip-flop has done the operation of dividing the frequency of the self-input CKN by 2, and the time delay of the latter stage is twice that of the upper stage.

The implementation of the frequency division circuit of CK/2 is shown in FIG. 3. The falling edge of CKN triggers locking and realizes Q=D, and the output signal Q of the flip-flop is output to its own D input terminal after inversion, so as to realize that every two CK cycles, the output terminal Q generates a periodic signal, so that the output clock frequency is reduced to half of the input clock frequency.

The flip-flop CLK may also be triggered using a rising edge, all that is needed is to invert the CLK after it enters the flip-flop. The flip-flop uses a D flip-flop or other flip-flops, the flip-flops belong to standard devices of the prior art, and the internal structure of the D flip-flop with resetting and setting functions can be referred to MC74HCT74A of the ON-SEMI Corporation.

The specific timing process is shown in FIG. 4B, when the set signal 415 is at a high level, after the clock module 406 and the counting module 405 receive a low-level pulse from the controllable tri-state gate 413, the low-level pulse is in a low-level period, and all the output terminals Q of the flip-flops in the module 405 are initialized to be at a low level. After the low-level pulse changes from low to high, timing is started, and the high level of the input terminal D of the flip-flop starts to be transmitted backward from the first stage flip-flop F1. When it is transmitted to the last stage Fn, the Fn output signal Qn changes from a low level to a high level, and timing is ended. From the circuit of FIG. 4B, it can be seen that Qn controls the starting and ending of the discharging unit through the controllable tri-state gate 412. When the enable terminal of the controllable tri-state gate 412 is at the high level, and Qn is at the low level, the discharging unit is started, and when Qn is at the high level, the discharging unit is closed.

In order to achieve low power consumption, the clock oscillation is stopped after the counting is ended, and the clock oscillation is waiting to be restarted. An embodiment is to disconnect the connection between the output terminal of the AND gate 424 and the resistor, add a new two-input AND gate, connect the output terminal of the new AND gate to the disconnected terminal of the resistor, connect the output terminal of the AND gate 424 to the first input terminal of the new AND gate, and connect the second input terminal of the new AND gate to the output Qn of the flip-flop Fn of the counting module 405.

After the timing unit starts timing, and before timing is ended, the timing unit does not restart timing when the voltage across the battery string is greater than the balancing starting threshold value VTHB again in step S1, so that the counting module 405 does not fall into frequent starting. See the AND gate 416 in FIG. 4B, the output Qn of the flip-flop Fn during timing by the timing unit is the low level, the output of the AND gate 416 is the low level, the output of the controllable tri-state gate 413 is high resistance state. A pull-up resistor pulls the level to the high level, and the counting module 405 fails to receive the low-level pulse emitted by the low pulse generation circuit 404 and does not restart counting. When timing is ended, the Fn output Qn becomes high, the output level of the controllable tri-state gate 413 follows the input level, the low-level pulse emitted by the low pulse generation circuit 404 can reach the counting module 405, and timing can be restarted.

The clocking unit may be implemented by an application specific integrated circuit (ASIC), or may be implemented using a programmable array logic (PAL), a programmable logic device (PLD), a field programmable gate array (FPGA), a general-purpose array logic (GAL), or the like to implement the clock module 406 and the counting module 405 as shown in FIG. 4B.

The timing unit can be realized by using the 555-series timer of the prior art. The 7555 series of CMOS low voltage is selected, and an appropriate RC value is selected, such as 2 megaohms for R and 470 microfarads for C, and according to the formula τ=R*C, timing can reach 15 minutes.

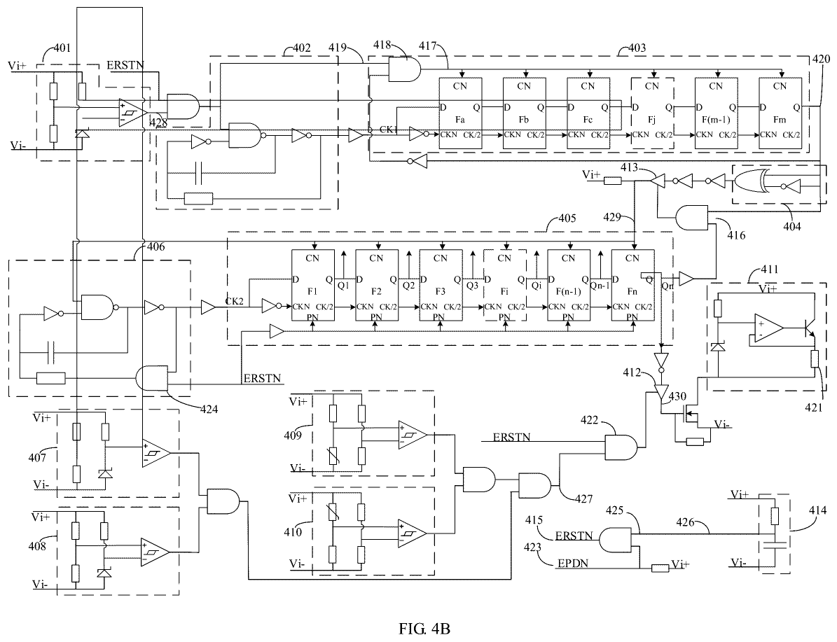

The timing unit may be implemented using a microprocessor (MCU). A short time delay can be achieved using the timer built in the MCU, for example, the timer built in the MCU can delay Δt3=100 ms, and then, in conjunction with software timing, long-term timing can be achieved. The implementation method is shown in FIG. 5: a variable i is defined with an initial value of 0, after receiving a timing starting signal, a loop is executed to automatically increment the variable i by 1 every Δt3 period until the variable i is equal to or greater than a specified value n, the loop is exited, the variable i=0 is reset, and a timing ending signal is issued. For example, when n equals 1048576, a timing duration of about 29 hours can be achieved, and different durations can be obtained by setting different values of n, which will not be described further herein.

The timing duration of the timing unit can easily reach 80 seconds, or even 2 hours to 10 days or more. Since the large-capacity battery pack needs to release a lot of power every time the balancing is started, discharging in a short period of time is likely to cause heat generation problems caused by high power. After the time is extended, the average power becomes lower and the heat generation problem is solved. The flip-flop outputs Q1, Q2, Q3 . . . Qn of the counting module 405 are different time bases and can be used directly or in combination to obtain a series of different durations for turning off the discharging unit. The maximum duration of the timer is determined by the frequency of the oscillator and the total number of stages of the flip-flop chain. If the frequency of the oscillator is 20 KHZ, then an oscillation period is 50 us. For a timing unit composed of an n-bit counter and a clock with a period of τ, the timing duration is t=2\hat{ }n*τ. A 32-bit counting unit theoretically has a maximum timing duration of t=2\hat{ }32*50 us≈60 hours. Similarly, a 40-bit counter can reach up to 640 days. As the calculated value represents a full cycle, but the available time for the timing unit in FIG. 4B is half a cycle, it is half of the calculated value. The clock frequency generated by the clock module 402 and the clock module 406 is determined by the values of R and C, and the delay of the supporting circuit. For low-frequency oscillators, the circuit delay accounts for a small proportion of the entire clock cycle and can be ignored. By selecting R=1M and C=50 PF, according to the RC oscillation period formula τ=R*C, the period can be roughly calculated as τ=1000000*50*10\hat{ }(−12)=50 us, with a frequency of 20 KHZ. By adjusting the values of R and C, different frequencies can be obtained. Combining the clocks of different frequencies with the counters of different numbers of stages, various timing durations can be achieved. The corresponding RC values and counter stage values for each duration can be specifically calculated using the formula t=2\hat{ }n*R*C, which will not be described further herein.

The balancing starting threshold value VTHB is smaller than the full charging threshold voltage VTHF of the battery string, which can be achieved by adjusting the voltage division ratio of the resistor at the non-inverting input terminal of the comparator in the voltage detection module 401 or by adjusting the voltage of the reference voltage source. Since the voltages of a plurality of battery strings in a battery pack cannot be exactly the same, if any battery string voltage exceeds VTHF during the charging process, the battery pack will be protected from overcharging and charging will stop. If VTHF is chosen as the balancing starting voltage, then in most cases, only one battery string in the entire battery pack would meet the balancing condition. The balancing starting voltage is selected to be a value lower than VTHF, which facilitates more battery strings to enter the balanced state after each battery pack is fully charged, and improves battery pack single-time balancing efficiency.

The starting of balanced discharging and timing should also be subject to the condition that the voltage across the battery string remains continuously higher than the balancing starting threshold value VTHB, with a recommended duration of Δt2 greater than 220 milliseconds. This is to prevent the voltage detection unit from falsely initiating the balanced discharging function due to interference. It is necessary to confirm whether the battery string voltage consistently exceeds the balancing starting threshold value VTHB and the balanced discharging starting condition must meet that the battery string voltage remains continuously higher than the balancing starting threshold value VTHB for a period of time to ensure that it is not caused by high-frequency interference. When the battery string voltage is smaller than the balancing starting threshold value VTHB, the clock module 402 and the counting module 403 are in a reset state, when the battery string voltage is greater than the balancing starting threshold value VTHB, the clock module 402 and the counting module 403 start timing, timing is ended, the signal 420 is changed from low to high, and the Fm output signal 420 in the counting module 403 passes through an inverter and is output to its own reset circuit, achieving self-resetting. The reset counter can generate balancing starting signals intermittently under the condition that the battery string voltage remains continuously higher than the starting voltage of the battery string. When the self-reset function of the timer 403 is not used, that is, the AND gate 418 in FIG. 4B is not used, the signal 417 and the signal 419 are directly connected together, so that the necessary condition for starting balanced discharging and timing is that the battery string voltage exceeds the balancing starting threshold value from low to high, and the advantage of this use is to prevent the problem that balanced discharging cannot be stopped at all times if the voltage detection unit erroneously outputs a high level at all times. Meanwhile, when the signal 420 changes from low to high, a balancing starting low pulse signal is generated by the low pulse generation circuit 404. If the output Qn of the Fn of the counting module 405 is high, the signal 420 remains high after passing through the AND gate 416, enabling the controllable tri-state gate. The low-pulse signal generated by the circuit 404 reaches the flip-flop CN terminal of the counting module 405 and the clock module 406, setting both the flip-flop and the clock source. After the low-pulse ends, the clock module 406 and the counting module 405 start timing, and the output Qn of the Fn is a low level, generating a discharging enable signal. In some applications where balancing is required to be started only after charging is completed, charging can be stopped after the battery string voltage Vi is higher than the balancing starting threshold value VTHB, and balancing can be started after the Vi voltage is lower than VTHB from high to low. The realization method is that the signal 420 is inverted before entering the AND gate 416, or the signal 420 does not participate in the enable terminal control of the controllable tri-state gate. In this way, Vi can be greater than VTHB from low to high or Vi is lower than VTHB from high to low, and a timing balancing starting signal can be generated.

An inverter circuit within the low-pulse generation circuit 404 possesses the functions of long delay and inversion. Engineers implementing this design should understand that this delay is utilized along with an XOR gate to generate a low-level pulse, whose duration should be sufficiently long for resetting the counting module 405. The two inverters connected to the output terminal of the low-pulse generation circuit 404 also have adequate delay, ensuring that the signal 420 and its variations reach the enable terminal of the controllable tri-state gate 413 earlier than they reach the input terminal of the controllable tri-state gate 413. Furthermore, the new enable signal has sufficient time to prevent or allow new input signals to pass through the tri-state gate. The working principle for timing of the counting module 403 and the clock module, is similar to that of the counting module 405 and the clock module 406, and thus will not be further discussed here.

The discharging unit is used for discharging the battery string, starting discharging the battery string upon receiving a discharging starting signal, and stopping discharging the battery string upon receiving a discharging stopping signal. The circuit is realized through the series connection of a controllable electronic switch and a discharging circuit. In this embodiment, a constant current source is used as the discharging circuit, such as the discharging circuit 411 shown in FIG. 4B. An NMOS connected in series with the discharging circuit is used as the controllable electronic switch, and by controlling the on/off state of the NMOS, discharging of the battery strings can be enabled or disabled. Of course, the electronic switch such as the PMOS, the triode, the relay, etc., can also be used, and then the corresponding control level or control circuit is used. For small current balancing, the control signal of a chip can be used to directly drive the discharging circuit to achieve the discharging function. The discharging circuit 411 in FIG. 4B is a form of constant current source: the reference voltage source is input to the non-inverting input terminal of the operational amplifier. The positive terminal of the feedback resistor 421 is connected to the inverting input terminal of the operational amplifier and also to the emitter of an NPN triode. The collector of the NPN triode is connected to the positive pole Vi+ of the battery string. The output of the operational amplifier is connected to the base of the NPN triode. The negative terminal of the constant voltage source and the negative terminal of the feedback resistor 421 are connected and further connected to the negative pole Vi− of the battery string through an NMOS transistor. The feedback resistor and the inverting input terminal of the operational amplifier form a negative feedback circuit. The larger the current flowing through the feedback resistor 421, the higher the voltage input to the inverting input terminal of the operational amplifier, and the lower the output voltage of the operational amplifier. This decreases the voltage at the base of the NPN triode, causing the current flowing through the feedback resistor 421 to decrease. Conversely, the current increases, forming a constant current source within a certain voltage range. In the discharging circuit 411, if the reference voltage source is set to 1.2V and the feedback resistor 421 is set to 60 ohms, a constant source current I=reference voltage/feedback resistance=20 mA can be obtained. The benefit of using a constant current source as a discharging circuit is that it facilitates achieving consistent balancing effects for different self-balancing devices under different battery conditions and voltages. The triode in the discharging circuit 411 can also be replaced with an NMOS, a PMOS, or a PNP triode, the latter two requiring interchanging connections at the supporting operational amplifier input terminals. After the input of the controllable tri-state gate 412 is high level and enabled, the NMOS is turned on, the discharging unit starts discharging. Conversely, discharging is stopped.

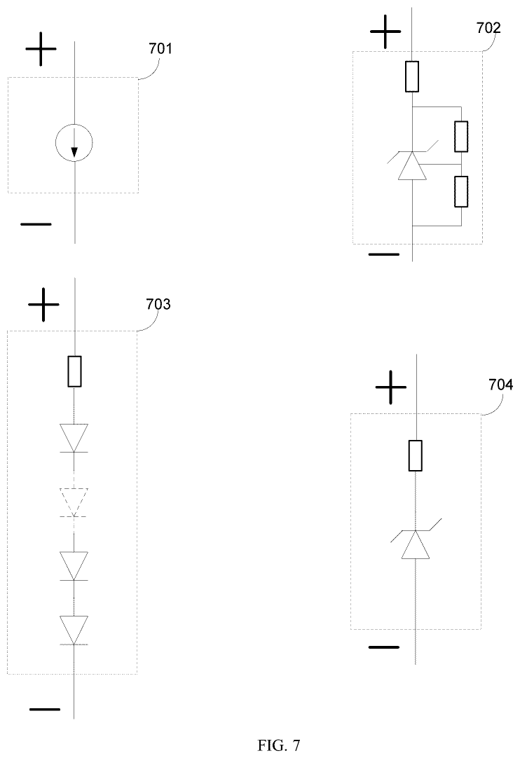

The implementation mode of the discharging circuit in the discharging unit includes but is not limited to a constant current source, a resistor, and the series connection of the constant voltage source and the resistor, etc., see FIG. 7. When the resistor is used as the discharging circuit, one or more resistors can be used in series or parallel to replace the module 411, the advantage of using pure resistors is lower cost. Alternatively, a resistor can be connected in series with a constant voltage source to form a discharging circuit. FIG. 7 shows several forms of discharging circuits that can replace the module 411 in FIG. 4B. In FIG. 7, the discharging circuit 701 is a constant current source; the module 702 uses TL431 to form a constant voltage source above 2.5V, which is connected in series with a resistor to form a discharging circuit; the module 703 is composed of a diode and a resistor in series, which acts as a constant voltage source, and the combination of the diode and the metal substrate can provide better heat dissipation performance; and 704 is composed of a voltage-regulator diode or a TVS and a resistor connected in series, and it is recommended to select a voltage regulator tube or TVS with a voltage around 2.5V. The benefit of using a constant voltage source as a discharging circuit is to prevent the battery from being completely discharged in the event that the discharging control section is out of control or the electronic switch is damaged.

The discharging unit is configured to prohibit discharging after an balancing prohibiting condition occurs, the balancing prohibiting condition including at least one of the following conditions: the battery string voltage Vi is smaller than the lowest balancing voltage threshold value VTHU; the battery string voltage Vi is greater than a voltage abnormally high threshold value VTHO; a self-balancing device temperature is greater than a high-temperature protection threshold value TTHO; and the ambient temperature is smaller than a low-temperature protection threshold value TTHU.

When there is a broken circuit or incorrect connection in the line connecting the voltage detection unit to the battery strings, it can lead to abnormally high or low detected voltages of adjacent battery strings. To prevent misjudgment caused by a broken circuit in the line connecting the voltage detection unit to the battery strings, the balancing prohibiting condition is set as: the battery string voltage Vi is greater than a voltage abnormally high threshold value VTHO. In terms of circuit implementation, the circuit in this embodiment is seen in the high-voltage detection module 407, which can be realized through a voltage comparator and a reference power supply. During the discharging process of the battery string, if it is found that the battery string voltage has already dropped below the lowest balancing voltage threshold value VTHU, continuing to discharge may affect the battery's subsequent endurance or pose a safety hazard to the battery. In this case, balancing is prohibited, and the circuit implementation method is seen in the low-voltage detection module 408. The high temperature of the self-balancing device may damage the device circuit, so when the self-balancing device temperature is greater than the high-temperature protection threshold value TTHO, balancing is prohibited. The circuit implementation method can be seen in the high-temperature detection module 409. Discharging lithium batteries under excessively low ambient temperatures may damage the battery, so when the ambient temperature is smaller than the low-temperature protection threshold value TTHU, balancing is also prohibited. The circuit implementation method can be seen in the low-temperature detection module 410. Here, the ambient temperature can be understood as the atmospheric temperature or battery cell temperature.

After any balancing prohibiting condition is generated, the corresponding comparator will output a low level. The outputs of comparators under all balancing prohibiting conditions are aggregated through an AND operation into a single output, which controls the enable terminal of the module's controllable tri-state gate 412. This achieves the effect of shutting down the discharging unit 411 and prohibiting discharging whenever any balancing prohibiting condition is generated. Once the balancing prohibiting condition disappears, the discharging function is restored. The signal 426 and the AND gate input terminal 425 are disconnected, and the result of the signal 426 and the signal 427 after the AND operation is output to the AND gate input terminal 425, after any balancing prohibiting condition occurs, the ongoing timing and balanced discharging are terminated until the timing and balanced discharging are started the next time.

Explanation of the principle of temperature testing and an example: taking the high-temperature detection module 409 as an example, a resistor and an NTC thermistor are connected in series for voltage division and then connected to the non-inverting input terminal of the comparator, and the other two fixed resistors are connected to the inverting input terminal of the comparator after being divided. The two groups of voltage dividing devices shares a common power source and a common ground. NTC is a type of thermistor that has a lower resistance value at higher temperatures. Each temperature corresponds to a fixed resistance value. By selecting the desired temperature protection point, the corresponding resistance value of the NTC at that temperature can be looked up in the NTC's specifications. By selecting a fixed-resistance-value resistor and the NTC divided voltage, the voltage division value at the temperature protection point can be calculated. The requirement for selecting the values of the other pair of resistors is to ensure that their voltage division value equals the voltage division value of the resistor and NTC at the temperature protection point. In this way, when the temperature exceeds the protection point temperature, the comparator outputs a low level. Conversely, when the temperature is below the protection point temperature, it outputs a high level. Further, the NTC is selected from the NTC model of “Shenzhen Kaibu Electronics Co., Ltd.”: TCTR0603F100KF, 4300T, and its corresponding resistance value at 80 degrees Celsius is 10.62K ohms. The resistor connected in series with the NTC is 100K ohms. The resistor connected to the inversing input terminal of the comparator and the Vi− is 10.62K ohms, and the other resistor is 100K, so that high temperature protection can be achieved at 80 degrees Celsius. The low-temperature detection module 410 follows a similar principle and will not be described in detail. Using the same rules, PTC thermistors can also be used. The higher the temperature of the PTC resistor, the higher the resistance. Similar to the principle of using NTC, the temperature detection unit can be formed by connecting PTC and resistors in series for voltage division and then connecting to the comparator.

To further reinforce safety, the self-balancing device further includes a thermal fuse connected in series in a power supply channel of the self-balancing device, and after the temperature of the self-balancing device is higher than the fuse limit temperature, the thermal fuse is disconnected and the self-balancing device is powered-off. A thermal fuse 600, as in FIG. 6, is used to ensure that the self-balancing device is disconnected in the event of thermal runaway due to any reason, thus ensuring safety. It is recommended to select a thermal fuse with a fusing temperature of 115 degrees Celsius, but other temperatures can also be chosen based on the specific circuit and application environment.

After the self-balancing means receives an external input stop signal, the self-balancing means stops or terminates the balanced discharging, such as an EPDN signal 423 in FIG. 4B, an external input signal can be received, for example, a manual switch can turn off the self-balancing device in a warehousing mode; or other situations where it is desirable to terminate or stop ongoing balanced discharging. After the EPDN signal 423 receives an external input low level or low-level pulse, both the timing unit and the discharging unit are set to a stop state, and if the self-balancing unit is already in a discharging and timing state at this time, timing and balanced discharging at this time is terminated. The EPDN signal 423 can also control the enable terminal of the controllable tri-state gate 412 based on the result of an AND operation between the output of the AND gate 422 and itself to replace the original control connection in FIG. 4B. When the EPDN signal 423 receives an external input low-level, it will only stop the ongoing balanced discharging, without stopping timing or other units. After the high level is restored, the balanced discharging unit is restored to its proper state.

The discharging time and discharging current are pre-designed based on the capacity of the battery pack to be balanced so that the amount of discharging power is a small proportion of the total capacity of the battery in a given time. The present embodiment is applied to a battery capacity of 100 AH, and a balanced battery string has a balanced discharging time of 18 hours and a discharging current of about 25 mA, so that the balanced discharging capacity is 18*25 mA=0.45 AH, which accounts for 0.45% of the total capacity of the battery. According to the user's habit of charging once a day or once a few days, the balancing maintenance can be automatically performed once per charging, the battery string whose voltage exceeds the balancing starting voltage is discharged to achieve the purpose of improving or maintaining the balanced state of the battery pack.

The self-balancing module mentioned in the present disclosure can be externally connected to an existing battery pack, it is also possible to integrate it directly with a battery string or with a single battery cell to form a self-balancing battery string or self-balancing battery cell. The battery pack formed from such battery strings or battery cells have the self-balancing function that increase the efficiency of assembling the battery pack and reduce the fault rate of battery pack assembly.

Taking the installation of balancing equipment on a bus as an example to illustrate the cost advantage of self-balancing devices: the bus is 10 meters long and has 8 battery compartments, with each compartment containing a 500 AH battery pack having 24 strings. Due to the large capacity of the bus battery pack, a traditional BMS cannot complete the balancing task, so a dedicated balancing device is usually installed.

By using the self-balancing device in the embodiment, an individual discrete circuit board module is designed. It is only necessary to connect a self-balancing circuit board module at both ends of each battery string. The total length of the balancing line for each module is 0.2 meters, and the total length of the balancing lines for all 8 compartments is 0.2*24*8=35.2 meters. The modules are fixed to the batteries inside each battery compartment through bonding, with a construction cost of less than one thousand yuan. If a battery pack assembled with self-balancing battery cells is applicable, there is no cost of construction in terms of balancing.

Using a centrally controlled balancing device, there is one balancing extension for each battery compartment, and 8 balancing extensions are connected to the balancing host. The tasks involved are: the balancing lines of the balancing extensions are connected, with 25 lines for 24 battery strings. Each balancing line is approximately 1.5 meters long. The total length of the balancing lines for each compartment is 1.5*25=37.5 meters, and the total length for all 8 compartments is 300 meters. There are 2 lines between the balancing extensions and the host, 2 power lines for the extensions and 2 lines for the coding. Since the wiring harness cannot be laid in a straight line, coupled with the interconnection of 8 compartments, the total length is generally calculated as 3 times the length of the bus, which is 10 m*3*2*3=180 meters. Nine sets of connectors, nine sets of aviation plugs are required for the connection between the extensions and the host. Since the communication and other wiring harnesses are outside the battery pack, they require drilling holes in the battery compartments and waterproof treatment. The wiring harnesses need to be sleeved and wrapped, and communication and power supply need to be isolated. Compared with the first solution, the additional cost of wiring harnesses, connectors, aviation plugs, etc. is over 2,000 yuan, and the construction cost is over 2,000 yuan. If it is installed on an old bus, modifications to the existing equipment may be required to accommodate the addition of the balancing equipment, which would further increase the cost. The market price for a set of centrally controlled balancing equipment installed on a bus in 2020 was 30,000 yuan.

From an energy-saving perspective, while the centralized balancing device on a bus maintains consistent balancing, the entire balancing system requires an additional consumption of approximately 20 W of actual power. However, with the balancing device in this embodiment, as the battery strings themselves directly supply power, the current consumption of the device can easily be kept below 1 mA. The total power consumption of the control part of the self-balancing device for all battery strings on the bus is below 0.5 W, which is 1/40 of the centralized balancing.

Apparently, embodiments described herein are just a few embodiments of the present disclosure. Based on the embodiments in the present disclosure, all other embodiments obtained by those of ordinary skill in this and related fields without making inventive effort, shall belong to the scope of protection of the present disclosure.

1. A series battery pack self-balancing device capable of independently working in a single string, each battery string in the series battery pack being provided with at least one self-balancing device for improving or maintaining the balanced state of the battery pack, wherein the self-balancing device is connected to positive and negative poles of the battery string through a conductor, the battery string provides a working voltage for the self-balancing device;
the self-balancing device comprises a voltage detection unit, a timing unit and a discharging unit, wherein the voltage detection unit is used for detecting a voltage across the battery string, and comparing the voltage with a threshold voltage to output a comparison result, the timing unit is used for timing and outputting a timing result, and the discharging unit is used for discharging the battery string;
the working process of the self-balancing device comprises the following steps:
S1: after detecting that the voltage across the battery string is greater than the balancing starting threshold voltage VTHB by the voltage detection unit, starting discharging of the battery string by the discharging unit, and starting timing by the timing unit; and
S2: stopping discharging by the discharging unit when the timing duration reaches a predetermined time Δt1.

2. The series battery pack self-balancing device according to claim 1, wherein the balancing starting threshold voltage V_{THB} is smaller than the battery string full charging threshold voltage V_{THF}, and Δt1 is greater than 80 seconds.

3. The series battery pack self-balancing device according to claim 1, wherein the voltage detection unit is implemented by a voltage comparator or ADC.

4. The series battery pack self-balancing device according to claim 1, wherein step S1 further comprises: when the voltage across the battery string continuously higher than the balancing starting threshold voltage VTHB with a duration of Δt2 greater than 220 msec, starting discharging of the battery string by the discharging unit, and starting timing by the timing unit.

5. The series battery pack self-balancing device according to claim 1, wherein the working process of the self-balancing device further comprises: the timing unit does not restart timing after the voltage across the battery string is greater than the balancing starting threshold voltage V_{THB} again during timing of the timing unit.

6. The series battery pack self-balancing device according to claim 1, wherein the working process of the self-balancing device further comprises: after a balancing prohibiting condition occurs, the discharging unit is configured to prohibit discharging or terminate discharging;
the balancing prohibiting condition comprises at least one of the following conditions:
the battery string voltage Vᵢ is smaller than the lowest balancing voltage threshold value V_{THU};
the battery string voltage Vᵢ is greater than a voltage abnormally high threshold value V_{THO}; a self-balancing device temperature is greater than a high-temperature protection threshold value T_{THO}; and
the ambient temperature is smaller than a low-temperature protection threshold value T_{THU}.

7. The series battery pack self-balancing device according to claim 1, further comprising a thermal fuse connected in series in a power supply channel of the self-balancing device, and after the temperature of the self-balancing device is higher than the fuse limit temperature, the thermal fuse is disconnected and the self-balancing device is powered off.

8. The series battery pack self-balancing device according to claim 1, wherein the timing unit comprises a clock source and a counter, the clock source being a RC oscillator or a crystal oscillator, and the counter composed of n flip-flops cascaded, n being greater than 21.

9. The series battery pack self-balancing device according to claim 1, wherein the timing unit is implemented using one or more of a 555-series timer, a MCU, an Application Specific Integrated Circuit, a FPGA, a PAL, a PLD, a GAL.

10. The series battery pack self-balancing device according to claim 1, wherein the discharging unit comprises a discharging circuit that is any one of:
a constant current source discharging circuit;
a resistive discharging circuit; and
a discharging circuit composed of at least one of a diode, a voltage regulator tube, and a regulated power supply connected in series with a resistor.

11. The series battery pack self-balancing device according to claim 1, wherein, after the self-balancing device receives an external input stop signal, the self-balancing device stops or terminates balanced discharging.

12. A self-balancing battery cell, comprising a battery cell and a self-balancing device, wherein the self-balancing device is connected to positive and negative poles of the battery cell through a conductor, the battery cell provides a working voltage for the self-balancing device;
the self-balancing device comprises a voltage detection unit, a timing unit and a discharging unit, wherein the voltage detection unit is used for detecting a voltage across the battery cell, and comparing the voltage with a threshold voltage to output a comparison result, the timing unit is used for timing and outputting a timing result, and the discharging unit is used for discharging the battery cell;
the working process of the self-balancing device comprises the following steps:
S1: after detecting that the voltage across the battery cell is greater than the balancing starting threshold voltage VTHB by the voltage detection unit, starting discharging of the battery cell by the discharging unit, and starting timing by the timing unit; and
S2: stopping discharging by the discharging unit when the timing duration reaches a predetermined time Δt1.

13. The self-balancing battery cell according to claim 12, wherein the balancing starting threshold voltage V_{THB} is smaller than the battery cell full charging threshold voltage V_{THF}, and Δt1 is greater than 80 seconds.

14. The self-balancing battery cell according to claim 12, wherein step S1 further includes: when the voltage across the battery cell continuously higher than the balancing starting threshold voltage V_{THB} with a duration of Δt2 greater than 220 msec, starting discharging of the battery cell by the discharging unit, and starting timing by the timing unit.

15. The self-balancing battery cell according to claim 12, wherein the working process of the self-balancing device further comprises: the timing unit does not restart timing after the voltage across the battery cell is greater than the balancing starting threshold voltage V_{THB} again during timing of the timing unit.

16. The self-balancing battery cell according to claim 12, wherein the working process of the self-balancing device further comprises: after a balancing prohibiting condition occurs, the discharging unit is configured to prohibit discharging or terminate discharging;
the balancing prohibiting condition comprises at least one of the following conditions:
the battery cell voltage Vᵢ is smaller than the lowest balancing voltage threshold value V_{THU};
the battery cell voltage Vᵢ is greater than a voltage abnormally high threshold value V_{THO}; a self-balancing device temperature is greater than a high-temperature protection threshold value T_{THO}; and
the ambient temperature is smaller than a low-temperature protection threshold value T_{THU}.

17. The self-balancing battery cell according to claim 12, further comprising a thermal fuse connected in series in a power supply channel of the self-balancing device, and after the temperature of the self-balancing device is higher than the fuse limit temperature, the thermal fuse is disconnected and the self-balancing device is powered off.

18. The self-balancing battery cell according to claim 12, wherein the timing unit comprises a clock source and a counter, the clock source being a RC oscillator or a crystal oscillator, and the counter composed of n flip-flops cascaded, n being greater than 21.

19. The self-balancing battery cell according to claim 12, wherein the discharging unit comprises a discharging circuit that is any one of:
a constant current source discharging circuit;
a resistive discharging circuit; and
a discharging circuit composed of at least one of a diode, a voltage regulator tube, and a regulated power supply connected in series with a resistor.

20. A battery string, comprising the self-balancing battery cell according to claim 12.
